(19) United States
(12) Patent Application Publication
(10) Pub. No.: US 2007/0188411 A1
(43) Pub. Date: Aug. 16, 2007

(54) Image display apparatus and method which switch drive sequences

(76) Inventors: Yoshiaki Takada, Yokohama (JP); Yutaka Chiaki, Yokohama (JP)

Correspondence Address: MCDERMOTT WILL & EMERY LLP, 600 13TH STREET, N.W., WASHINGTON, DC, 20005-3096, US

(21) Appl. No.: 11/593,157

(22) Filed: Nov. 6, 2006

(30) Foreign Application Priority Data
Feb. 15, 2006 (JP) 2006-038525

(51) Int. Cl. G09G 3/28

(52) U.S. Cl. 345/63

(57) ABSTRACT

An image display apparatus includes a displayed-subfield selecting circuit configured to select a lit-up pattern table from a plurality of lit-up pattern tables in response to an input image signal, a gain-characteristic generating circuit configured to select, from a plurality of gain characteristics, a gain characteristic corresponding to the selected lit-up pattern table, and a gain control circuit configured to produce a gain-limited image signal made by limiting a maximum level of the input image signal in response to the selected gain characteristic, wherein the on/off state of subfields is controlled in response to a level of the gain-limited image signal in accordance with the selected lit-up pattern table, thereby displaying a multi-level image on a display panel.

### BACKGROUND OF THE INVENTION

1. Field of the Invention

The present invention generally relates to image display apparatuses and methods for driving such apparatuses, and particularly relates to an image display apparatus and method for driving such apparatus which are suited to drive a plasma display panel (PDP).

2. Description of the Related Art

In recent years, there has been a demand for flat-screen display apparatuses as the size of display apparatuses increases. In response to such a demand, various types of flat-screen display apparatuses are provided. Examples include matrix panels that display digital signals as they are, e.g., a gas discharge panel such as a PDP, a DMD (digital micromirror device), an EL display device, a fluorescence display tube, a liquid crystal display device, and the like. Among these flat-screen display apparatuses, a gas discharge panel has advantages such as being suitable for a large-size screen, providing a self-luminous screen having high display quality, and providing high-speed response. Because of these advantages, a gas discharge panel has been put into practical use as a HDTV (high-definition TV) display device that has a direct-view-type large screen.

A plasma display apparatus has a plurality of weighted subfields (SF: lighting blocks) that are provided in each field (frame) and comprised of address pulses and a plurality of sustain discharge pulses (sustain pulses), and displays an image through the controlling of grayscale tones by selectively turning on/off these subfields. In such image display apparatus that displays a plurality of tones through the controlling of on/off states of the subfields, it is desired to improve the ability to properly display low luminance areas. In detail, it is desired to reduce the adverse effect of switching of drive sequences and to improve the ability to properly represent low luminance areas while avoiding frequent switching of drive sequences.

Conventional display drive methods for improving the ability to properly represent low luminance image areas include a method that switches drive sequences so as to increase the number of grayscale levels in the lower luminance zone when there are subfields that do not light up due to the low maximum brightness of the displayed image. Assuming that subfields SFmin to SFmax are used to display an image in the drive sequence prior to switching, a subfield SFmin-1 having half a weight (length) of the minimum subfield SFmin may be used in place of the maximum weight (length) subfield SFmax in the drive sequence after the switching, such that the subfields SFmin to SFmax-1 and SFmin-1 are used to display an image. In this case, the maximum luminance that can be displayed is lowered, but the number of grayscale levels in the lower luminance zone can be increased.

There is a further improved method (see Patent Document 1) in which drive sequences are switched when the utilization rate of SFmax drops below a certain threshold, thereby reducing an adverse visual effect that occurs at the time of switching, and, also, hysteresis characteristics are given to the threshold for switching drive sequences, thereby prolonging the period during which the switched drive sequence is used.

### [Patent Document 1] Japanese Patent Application Publication No. 2005-234369

In these conventional methods, when the utilization rate of the maximum weight subfield SFmax, while being not zero, drops below the threshold to trigger the switching of drive sequences, the grayscale levels of pixels that are supposed to use the subfield SFmax that still remains to be used infrequently are changed into completely different grayscale levels because of the nonexistence of the subfield SFmax that is supposed to light up. In this case, correct luminance cannot be represented, and a large shift in color may be observed.

Accordingly, there is a need for an image display apparatus and method for driving the apparatus that can reduce a change in color at the time of switching drive sequences.

### SUMMARY OF THE INVENTION

It is a general object of the present invention to provide an image display apparatus and method for driving the apparatus that substantially obviate one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by an image display apparatus and method for driving the apparatus particularly pointed out in the specification in such full, clear, concise, and exact terms as to enable a person having ordinary skill in the art to practice the invention.

To achieve these and other advantages in accordance with the purpose of the invention, the invention provides an image display apparatus, which divides one field into a plurality of weighted subfields, and controls a on/off state of the subfields in accordance with a lit-up pattern table defining an on/off state of each of the subfields with respect to each level of an input image signal, thereby displaying a multi-level image on a display panel. The image display apparatus includes a displayed-subfield selecting circuit configured to select a lit-up pattern table from a plurality of lit-up pattern tables in response to an input image signal, a gain-characteristic generating circuit configured to select, from a plurality of gain characteristics, a gain characteristic corresponding to the selected lit-up pattern table, and a gain control circuit configured to produce a gain-limited image signal made by limiting a maximum level of the input image signal in response to the selected gain characteristic, wherein the on/off state of the subfields is controlled in response to a level of the gain-limited image signal in accordance with the selected lit-up pattern table, thereby displaying a multi-level image on the display panel.

According to another aspect of the present invention, a method of driving an image display apparatus, which divides one field into a plurality of weighted subfields, and controls a on/off state of the subfields in accordance with a lit-up pattern table defining an on/off state of each of the subfields with respect to each level of an input image signal, thereby displaying a multi-level image on a display panel, includes a step of selecting a lit-up pattern table from a plurality of lit-up pattern tables in response to an input image signal, a step of selecting, from a plurality of gain characteristics, a gain characteristic corresponding to the selected lit-up pattern table, a step of producing a gain-limited image signal made by limiting a maximum level of the input image signal in response to the selected gain characteristic, and a step of displaying a multi-level image on the display panel by controlling the on/off state of the subfields in response to a level of the gain-limited image signal in accordance with the selected lit-up pattern table.

According to at least one embodiment of the present invention, the maximum level of an image signal is limited by switching gain characteristics at the time of switching drive sequences, so that no pixels any longer uses the subfield that is replaced at the time of switching drive sequences. With this arrangement, under no circumstances, does the luminance of a lit-up pixel change due to the discarding of part of a lit-up pattern at the time of switching drive sequences. Although there may be a change in the luminance of pixels due to the switching of gain characteristics, the use of a curve having gentle changes for the characteristics (gain characteristics) representing the output grayscale tones relative to the input grayscale tones can reduce an odd visual appearance of luminance and color changes associated with the switching of drive sequences. Further, the use of the same gain characteristics for the three primary colors in common can avoid a change in the ratio of the three primary colors upon the switching of lit-up pattern tables, thereby reducing a change in displayed color.

### BRIEF DESCRIPTION OF THE DRAWINGS

Other objects and further features of the present invention will be apparent from the following detailed description when read in conjunction with the accompanying drawings, in which:

FIG. 1 is a block diagram showing a first embodiment of an image display apparatus according to the present invention;

FIG. 2 is a block diagram showing an example of the multi-level processing circuit of the image display apparatus according to the present invention;

FIG. 3 is a drawing showing a first example of a lit-up pattern table in the SF converting circuit of the image displaying apparatus according to the present invention;

FIG. 4 is a drawing showing a second example of a lit-up pattern table in the SF converting circuit of the image displaying apparatus according to the present invention;

FIG. 5 is a drawing showing a third example of a lit-up pattern table in the SF converting circuit of the image displaying apparatus according to the present invention;

FIG. 6 is a block diagram showing an example of the error-diffusion control circuit shown in FIG. 2;

FIG. 7 is a block diagram showing an example of the SF-utilization-rate detecting circuit of the image display apparatus according to the present invention;

FIG. 8 is a block diagram showing an example of the displayed-SF selecting circuit of the image display apparatus according to the present invention;

FIG. 9 is a drawing showing an example of the table of outputs of the displayed-SF selecting circuit of the image display apparatus according to the present invention;

FIG. 10 is a drawing showing an example of a drive sequence used by a drive control circuit of the image display apparatus according to the present invention;

FIG. 11 is a block diagram showing an example of the drive control circuit of the image display apparatus according to the present invention;

FIG. 12 is a drawing showing an example of the table of outputs of the gain-characteristic generating circuit of the image display apparatus according to the present invention;

FIG. 13 is a drawing showing gain characteristics generated by the gain-characteristic generating circuit of the image display apparatus according to the present invention;

FIG. 14 is a flowchart showing an example of a displayed-SF selection process performed by the image displaying apparatus according to the present invention;

FIG. 15 is a block diagram showing a second embodiment of an image display apparatus according to the present invention;

FIG. 16 is a drawing showing an example of the table of outputs of the gain-characteristic generating circuit of the image display apparatus according to the present invention;

FIG. 17 is a drawing showing gain characteristics of the third embodiment according to the present invention;

FIG. 18 is a drawing showing the gain characteristics of a fourth embodiment according to the present invention for the case in which SFb10 is used and for the case in which SFb10 is not used;

FIG. 19 is a drawing showing the gain characteristics of a fourth embodiment according to the present invention for the case in which SFb10 is used and for the case in which SFb9 and/or SFb10 are not used;

FIG. 20 is a flowchart showing an example of a displayed-SF selection process performed by the image displaying apparatus according to the present invention;

FIG. 21 is a drawing showing an example of the gain characteristic selected in the case of M=30 in FIG. 20;

FIG. 22 is a drawing showing an example of the gain characteristic selected in the case of M=10 in FIG. 20; and

FIG. 23 is a drawing showing an example of the hysteresis characteristics of the output of the displayed-SF selecting circuit in the image display apparatus according to the present invention.

### DESCRIPTION OF THE PREFERRED EMBODIMENTS

In the following, embodiments of the present invention will be described with reference to the accompanying-drawings.

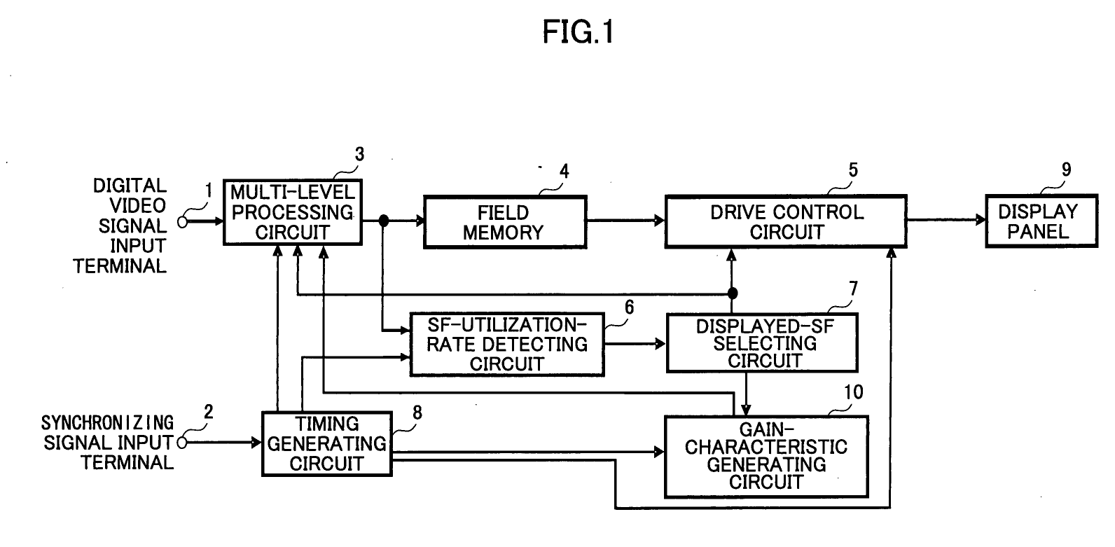

FIG. 1 is a block diagram showing a first embodiment of an image display apparatus according to the present invention. FIG. 1 shows a digital video signal input terminal 1, a synchronizing signal input terminal 2 for receiving a horizontal synchronizing signal, a vertical synchronizing signal, a display-period signal indicative of a display period, a clock signal, and the like, a multi-level processing circuit 3, a field memory 4, a drive control circuit 5, an SF-utilization-rate detecting circuit 6, a displayed-SF selecting circuit 7, a timing generating circuit 8, a display panel 9, and a gain-characteristic generating circuit 10.

The multi-level processing circuit 3 performs signal processing necessary for the PDP displaying of video signals input into the digital video signal input terminal 1, and supplies the processed signals to the field memory 4 and to the SF-utilization-rate detecting circuit 6. The field memory 4 stores data for one field supplied from the, multi-level processing circuit 3. The drive control circuit 5 reads the stored data for one field separately for each subfield successively during the field period next following the period in which the data for one field is stored in the field memory 4. The read data is supplied to the display panel 9. The display panel 9 may be a plasma display panel, for example, and includes various types of drivers (e.g., an X driver, a Y driver, and an address driver in the case of a tri-electrode alternating-current-drive-type PDP).

The timing generating circuit 8 serves to generate various types of timing signals such as synchronizing signals.

The SF-utilization-rate detecting circuit 6 detects the number of pixels to light up in each subfield, and supplies the detection result to the displayed-SF selecting circuit 7. The larger the number of pixels used in larger-weight (longer-period) subfields, the brighter the image as a whole. In response to the output of the SF-utilization-rate detecting circuit 6 that indicates the grayscales (brightness/darkness) of the image as a whole, the displayed-SF selecting circuit 7 outputs a selection signal that selects one of a plurality of lit-up pattern tables. Here, the lit-up pattern table defines which subfield(s) should be lit up among the plurality of subfields with respect to each gray scale tone of the digital video signals to be displayed.

For example, 10 subfields from SFb1 to SFb10 may be provided, and 8 subfields from SFb3 to SFb10 are used when the image as a whole is bright. In this case, fine tones corresponding to SFb1 and SFb2 can only be recovered through an error diffusion process, which means that the ability to represent these fine tones is degraded. When the image as a whole is dark, 8 subfields from SBb1 through SFb8 are used. This improves the ability to represent fine tones. In this case, the lit-up pattern tables are defined such that the brighter grayscale tones for which at least one of SFb9 and SFb10 is lit up are saturated.

The selection signal indicative of the selected lit-up pattern table output from the displayed-SF selecting circuit 7 is supplied to the multi-level processing circuit 3, the drive control circuit 5, and the gain-characteristic generating circuit 10. The drive control circuit 5 selects subfields (e.g., SFb3 through SFb10 among SFb1 through SFb10) corresponding to the selection signal, and reads the image display data from the field memory 4 for provision to the display panel 9.

The gain-characteristic generating circuit 10 generates gain-characteristic information in response to the output of the displayed-SF selecting circuit 7, and supplies the information to the multi-level processing circuit 3. Here, the gain-characteristic information is data that represents a gain-characteristic curve. The multi-level processing circuit 3 changes the gain characteristics of the digital video information in response to the gain-characteristic information supplied from the displayed-SF selecting circuit 7.

In a case where the drive sequence using the 8 subfields SFb1 through SFb8 is employed, for example, the bright pixels that are supposed to light up SFb10 and/or SFb9 are saturated, so that these pixels are lowered in luminance to the maximum level at which all the subfields SFb1 through SFb8 are lit up. As a result, replacement by completely different grayscale tones occurs as previously described, so that correct luminance cannot be represented, and a large shift in color may be observed.

In the present invention, a process for changing the gain characteristics of digital video signals is performed in advance at the multi-level processing circuit 3 in order to reduce a change in color caused by the switching of drive sequences. In the case of a drive sequence by which the maximum luminance Lmax can be expressed by use of the 8 subfields SF1b through SFb8, the gain characteristics are set such that the gain of video signals corresponding to the bright tones for which SFb10 and/or SFb9 are lit up among the tones presentable by use of SFb1 through SFb10 is lowered such that the resultant gain gradually increases up to the maximum luminance Lmax. With this provision, it is possible to avoid changes in luminance and color caused by the saturation of the grayscale tones of bright pixels even when lit-up pattern tables are switched.

Even when gain characteristics are adjusted as in the present invention, the lowering in the luminance of bright pixels cannot be avoided. However, the use of a curve having gentle changes for the characteristics (gain characteristics) representing the output grayscale tones relative to the input grayscale tones can reduce an odd visual appearance of luminance and color changes associated with the switching of drive sequences. Further, the use of the same gain characteristics for the three primary colors in common can avoid a change in the ratio of the three primary colors upon the switching of lit-up pattern tables, thereby reducing a change in displayed color.

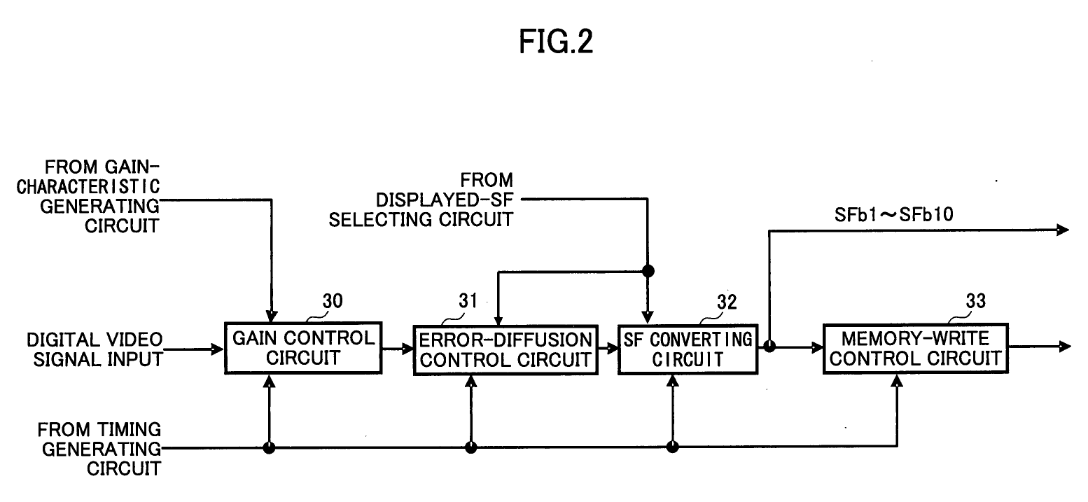

FIG. 2 is a block diagram showing an example of the multi-level processing circuit 3 of the image display apparatus according to the present invention. FIG. 2 shows a gain control circuit 30, an error-diffusion control circuit 31, an SF converting circuit 32, and a memory-write control circuit 33 for controlling the write operation to the field memory 4.

The gain control circuit 30 receives the digital video signals input into the digital video signal input terminal 1, and converts the grayscale tones of the digital video signals in accordance with the gain characteristics indicated by the gain characteristic information supplied from the gain-characteristic generating circuit 10. Such conversion can easily be implemented by use of a combinatorial logic circuit, for example. Alternatively, such conversion may be implemented by use of a conversion table utilizing a memory.

The digital video signals having its gain characteristics converted by the gain control circuit 30 are supplied to the error-diffusion control circuit 31. The error-diffusion control circuit 31 spatially diffuses the information about fine grayscale tones that are discarded through reduction in the numbers of bits when the number of bits used to display an actual image is smaller than the number of bits used to represent the original digital video signals. Through the spatial diffusion of rounding errors, spatial representation by use of a plurality of pixels is achieved, thereby visually representing a larger number of grayscale tones than the number of grayscale tones that can be represented by the number of bits assigned to each pixel for use in the actual presentation of an image. In the present invention, the positions of bits used in the displaying of an image are changed as lit-up pattern tables are switched, so that the number of discarded bits in the error diffusion process by the error-diffusion control circuit 31 is also changed in response to this change.

The memory-write control circuit 33 has one line memory, which temporarily stores video data that are converted into subfield data for one line. The memory-write control circuit 33 writes, to the field memory 4, the subfield data for one line stored in the line memory separately for each subfield SFb.

The SF converting circuit 32 stores therein a plurality of lit-up pattern tables, and selects one lit-up pattern table in response to the selection signal supplied from the displayed-SF selecting circuit 7. The SF converting circuit 32 converts the grayscale data of each pixel supplied from the error-diffusion control circuit 31 into subfield switch-on/off data in accordance with the selected lit-up pattern table. In this embodiment, the lit-up pattern tables stored in the SF converting circuit 32 include three types A through C. The switching of these three lit-up pattern tables is performed in response to the utilization rate of the subfields.

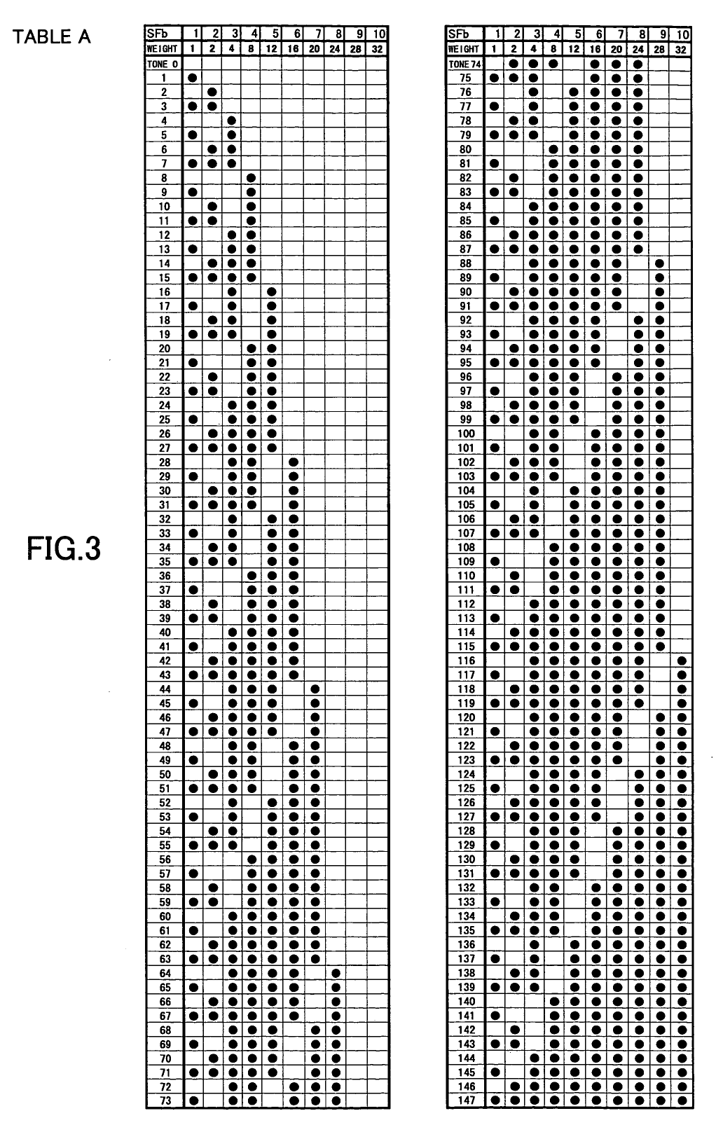

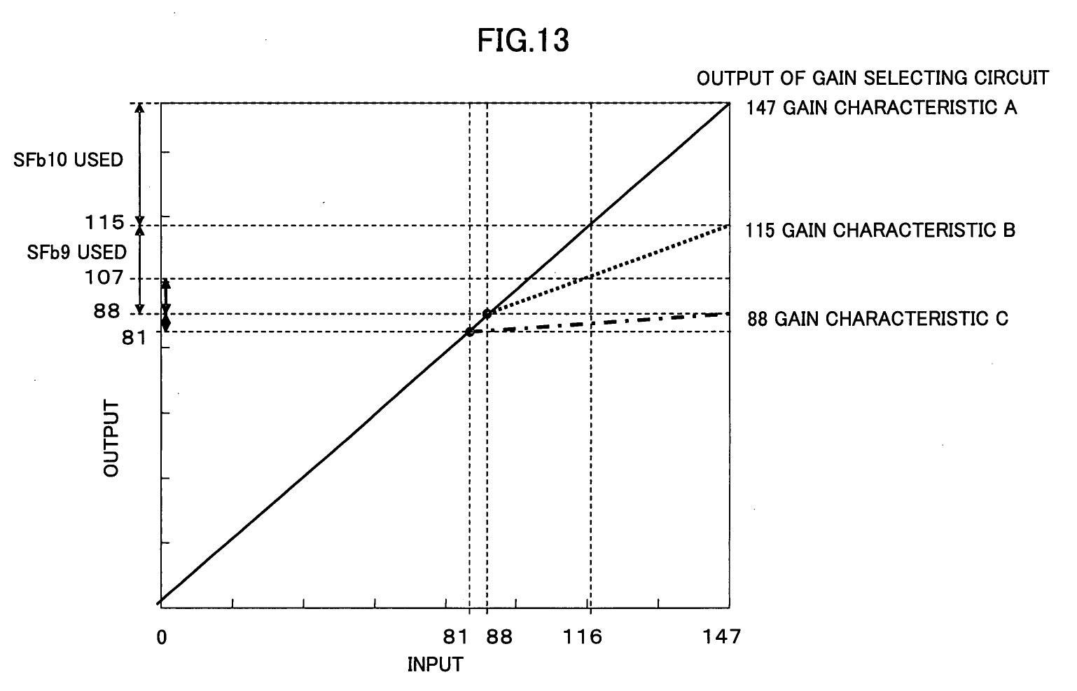

FIG. 3 through FIG. 5 are drawings showing the lit-up pattern tables A through C that are examples of the plurality of lit-up pattern tables used in the SF converting circuit 32 of the image display apparatus of the present invention. In these figures, the symbol “•” indicates the switched-on (lit-up) state. FIG. 13 shows gain characteristics A through C used in one-to-one correspondence to the lit-up pattern tables A through C, respectively.

In the following, operations will be described in detail. The lit-up pattern table A shown in FIG. 3 is used when the utilization rate of the subfield SFb10 is larger than a predetermined value. When the lit-up pattern table A is selected, the subfields that are actually used for the drive purpose among SFb1 through SFb10 are 8 subfields SFb3 through SFb10. The subfield SFb9 is used for the grayscale tone “88” and larger, and the subfield SFb10 is additionally used for the grayscale tone “116” and larger.

When the lit-up pattern table A is selected, SFb1 and SFb2 are discarded as display bits, so that the ability to represent a fine tone change in each pixel will be lost. However, information about the fine tones corresponding to SFb1 and SFb2 will be recovered through spatial diffusion by an error diffusion process.

The gain characteristic A (FIG. 13) that is used when the lit-up pattern table A is selected serves to output the video signals supplied to the gain control circuit 30 after multiplying the values of the video signals by 1. In this case, thus, the input and output of the gain control circuit 30 are the same.

In this embodiment, the presence/absence of lit-up data for the subfields SFb9 and SFb10 is checked so as to detect the utilization rate of the subfields. If the lit-up rate of the subfield SFb10 is low, the use of the subfield SFb10 is stopped, and switching is performed to the lit-up pattern table B using the subfield SFb2 in place of SFb10. This is done to improve the ability to represent lower luminance areas by increasing the number of grayscale tones in the lower luminance side when the brightness of the displayed image is low.

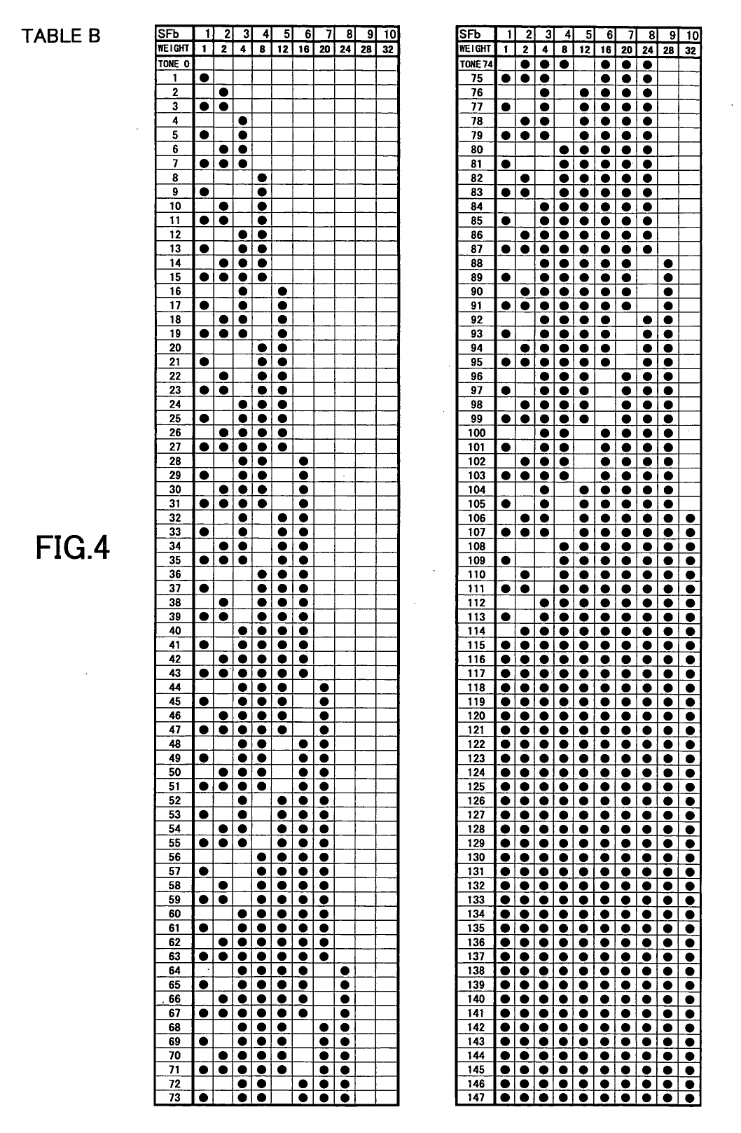

FIG. 4 shows the lit-up pattern table B. The subfields SFb used in the lit-up pattern table B for the drive purpose are the 8 subfields SFb2 through SFb9. There is a need to saturate the grayscale tones larger than the tone “115” for which all the subfields SFb1 through SFb9 are lit up, so that SFb1 through SFb9 are all lit up for these grayscale tones. If the subfields SFb2 through SFb9 of the lit-up pattern table as shown in FIG. 3 are used in the displaying of an image rather than using the arrangement shown in FIG. 4, the grayscale tone “116” will be displayed darker than the grayscale tone “115”, for example, because the subfield SFb10 is not used. This is the reason why the arrangement as shown in FIG. 4 is used.

The data indicative of switching on/off of the subfield SFb10 is not used in the displaying of an image, but is used for the purpose of determining the utilization rate of the subfields by counting the number of pixels for which the subfield SFb10 is lit up. As previously described, the switching of lit-up pattern tables is performed in response to the utilization rate.

In order to reduce a color change occurring at the time of switching drive sequences from the lit-up pattern table A to the lit-up pattern table B, the gain characteristic B that limits the maximum amplitude of the input image signals is used for the purpose of removing pixels for which the subfield SFb10, the use of which is to be stopped after the switching, is lit up.

The gain characteristic B shown in FIG. 13 outputs the input video signal values after multiplication by 1 until the grayscale tone reaches “88”, but has a straight line having a smaller slope for the grayscale tones above “88”. With this arrangement, the output values of the gain characteristic B are designed to be smaller than the grayscale tone “116”, which is the minimum tone for which SFb10 is lit up in the case of the lit-up pattern table A. As a result, even when a signal having a large value is input, the output does not reach a value for which SFb10 would need to be used. In other words, the output values of the gain characteristic B are designed to be smaller than or equal to the grayscale tone “115”, which is the maximum tone that can be represented by use of the lit-up pattern table B. As a result, even when a signal having a large value is input, the output never saturates.

It should be noted that the number of pixels for which the subfield SFb10 is lit up needs to be the same for the same input image regardless of the selected gain characteristic. This is because the number of pixels for which the subfield SFb10 is lit up is used as an indicator for the switching of lit-up pattern tables. When the gain characteristic A shown in FIG. 13 is used, as shown in the figure, the pixels for which the subfield SFb10 is lit up are those corresponding to the input grayscale tones “116” and larger. When the gain characteristic B shown in FIG. 13 is used, on the other hand, the pixel having the input grayscale tone “116” is converted into the output grayscale tone “106”.

The lit-up pattern table B shown in FIG. 4 is then employed, with the output grayscale tones after the gain conversion as described above being used as input data. Accordingly, there is a need to set the lit-up pattern table such that the subfield SFb10 is lit up for the grayscale tones “106” and larger in the lit-up pattern table B shown in FIG. 4.

In the present embodiment, if none of the subfields SFb10 and SFb9 is used, the use of the subfields SFb9 and the subfield SFb10 is stopped, and switching is performed to the lit-up pattern table C using the subfield SFb1 and the subfield SFb2 in place of SFb9 and SFb10.

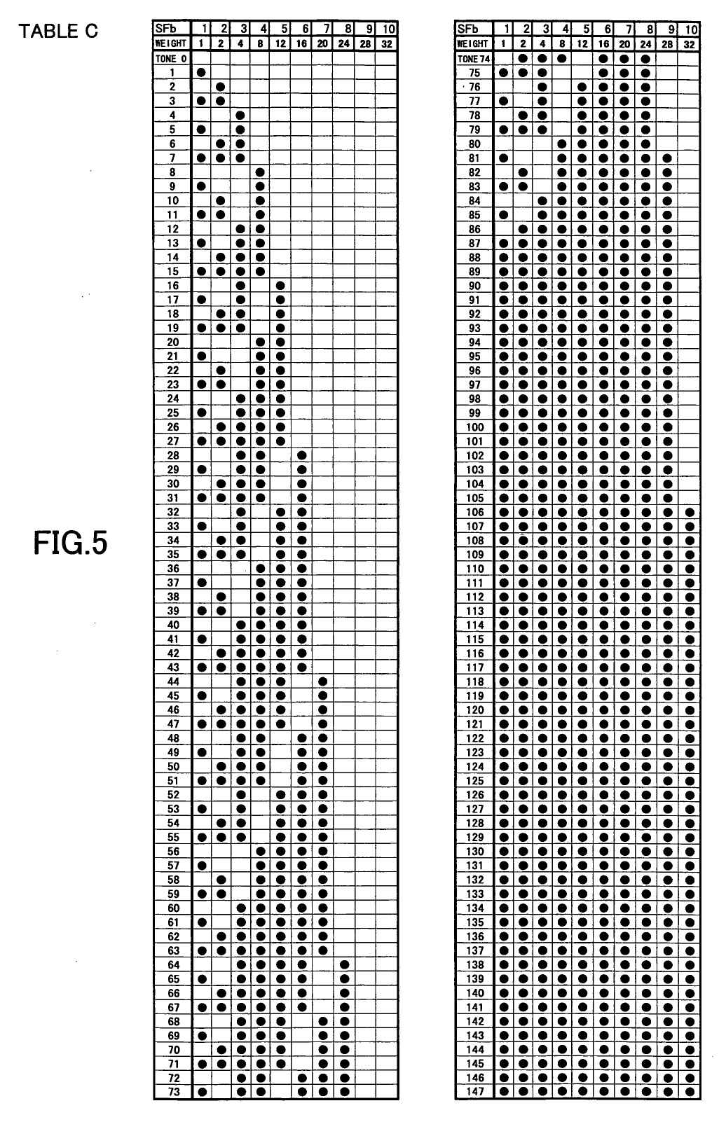

FIG. 5 shows the lit-up pattern table C. The subfields SFb used in the lit-up pattern table C for the drive purpose are the 8 subfields SFb1 through SFb8. There is a need to saturate the grayscale tones larger than the tone “115” for which all the subfields SFb1 through SFb8 are lit up, so that SFb1 through SFb8 are all lit up for these grayscale tones.

The data indicative of switching on/off of the subfields SFb9 and SFb10 is not used in the displaying of an image, but is used for the purpose of determining the utilization rate of the subfields by counting the number of pixels for which the subfields SFb9 and/or SFb10 are lit up. As previously described, the switching of lit-up pattern tables is performed in response to the utilization rate.

Further, gain characteristics are switched to use the gain characteristic C shown in FIG. 13. The gain characteristic C outputs the input video signal values after multiplication by 1 until the grayscale tone reaches “81”, but has a straight line having a smaller slope than the gain characteristic B for the grayscale tones above “81”. With this arrangement, the output values of the gain characteristic C are designed to be smaller than the grayscale tone “88”, which is the minimum tone for which SFb9 is lit up in the case of the lit-up pattern table B. As a result, even when a signal having a large value is input, the output does not reach a value for which SFb9 or SFb10 would need to be used. In other words, the output values of the gain characteristic C are designed to be smaller than or equal to the grayscale tone “87”, which is the maximum tone that can be represented by use of the lit-up pattern table C. As a result, even when a signal having a large value is input, the output never saturates.

It should be noted that the number of pixels for which the subfields SFb9 and SFb10 are lit up needs to be the same for the same input image regardless of the selected gain characteristic. This is because the number of pixels for which the subfields SFb9 and/or SFb10 are lit up is used as an indicator for the switching of lit-up pattern tables. When the gain characteristic A or B shown in FIG. 13 is used, as shown in the figure, the pixels for which the subfield SFb9 is lit up are those corresponding to the input grayscale tones “88” and larger. When the gain characteristic C shown in FIG. 13 is used, on the other hand, the pixel having the input grayscale tone “88” is converted into the output grayscale tone “81”.

The lit-up pattern table C shown in FIG. 5 is then employed, with the output grayscale tones after the gain conversion as described above being used as input data. Accordingly, there is a need to set the lit-up pattern table such that the subfield SFb9 is lit up for the grayscale tones “81” and larger in the lit-up pattern table C shown in FIG. 5. Further, the data indicating a lit-up state for grayscale tones “106” through “115” is set with respect to the subfield SFb10.

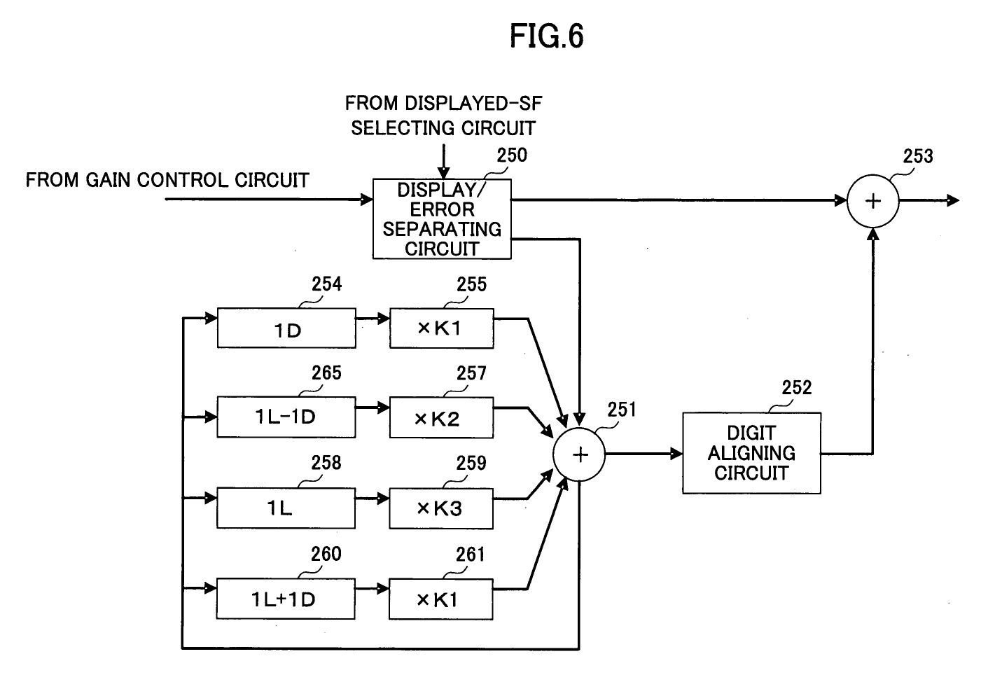

FIG. 6 is a block diagram showing an example of the error-diffusion control circuit 31 shown in FIG. 2. FIG. 6 shows a display/error separating circuit 250 for separating display bits from diffused bits, a one-pixel (1D) delay circuit 254, a one-line−one-pixel (1L−1D) delay circuit 256, a one-line (1L) delay circuit 258, and a one-line+one-pixel (1L+1D) delay circuit 260. Further, FIG. 6 shows a multiplying circuit 255 with a multiplication factor of K1, a multiplying circuit 257 with a multiplication factor of K2, a multiplying circuit 259 with a multiplication factor of K3, a multiplying circuit 261 with a multiplication factor of K4, adder circuits 251 and 253, a digit aligning circuit 252 for aligning bits in order for the adder circuit 253 to add the carry data from the adder circuit 251 to the display bits output from the display/error separating circuit 250. The adder circuit 253 then adds the bits separated by the display/error separating circuit 250 and the bits output from the digit aligning circuit 252 in accordance with the display grayscale tones.

When the 8 subfields SFb3 through SFb10 are driven for display, the grayscale tones that can be represented by the subfields SFb3 through SFb10 are 37 tones, which is equal to 148/4 inclusive of the grayscale tone “0”, and the total of 37 tones can be represented by use of 6 bits, so that the bits other than the 6 most significant bits (MSBs) are added together in order to spatially represent the data corresponding to the bits other than the 6 MSBs, and displaying is performed in response to the presence of a carry. When the subfields SFb2 through SFb9 are driven for display, data corresponding to the bits other than the 7 MSBs may be spatially represented.

As was previously described, the positions of bits used in the displaying of an image are changed as lit-up pattern tables are switched, so that the number of discarded bits in the error diffusion process by the error-diffusion control circuit 31 is also changed in response to this change. Namely, the bit position at which the display bits are separated from the diffused bits in the display/error separating circuit 250 is changed in response to the selection signal indicative of the selected lit-up pattern table supplied from the displayed-SF selecting circuit 7.

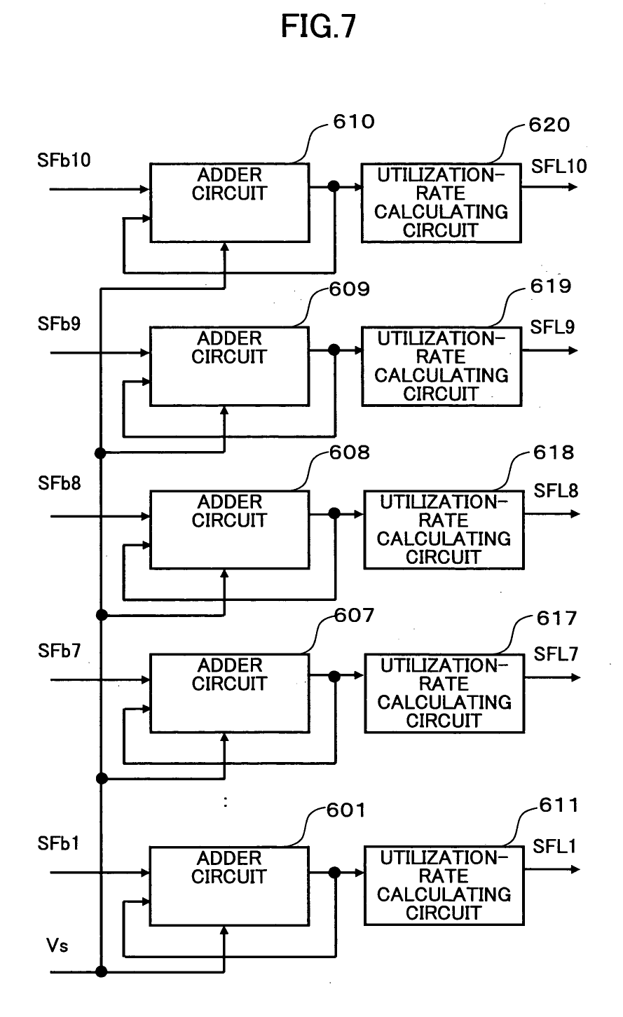

FIG. 7 is a block diagram showing an example of the SF-utilization-rate detecting circuit 6 of the image display apparatus according to the present invention. FIG. 7 shows adder circuits 601 through 610 and utilization-rate calculating circuits 611 through 620.

The adder circuits 601 through 610 performs addition for the entirety of one field with respect to the respective subfields SFb1 through SFb10 that are subfield-converted by the multi-level processing circuit 3. Further, the utilization-rate calculating circuits 611 through 620 normalize the results of the additions separately for each field by dividing the results of the additions by the total numbers of pixels included in the respective subfields SFb1 through SFb10, thereby obtaining utilization rates SFL1 through SFL10 that indicate proportions in the total numbers of pixels.

Here, the adder circuits 601 through 610 need to be able to handle numbers of bits that can represent the total number of pixels on screen. If the number of pixels is 640 dots in the horizontal direction and 480 dots in the vertical direction, for example, the total number of pixels is 307200 dots, which require 20 bits.

In the preset embodiment, however, the output bits of each of the utilization rates SFL1 through SFL10 do not necessarily have to use all the 20 bits, and may use fewer than 20 bits. The reason is as follows. The number of output bits of each of the utilization rates SFL1 through SFL10 is comparable to the thresholds that are used to determine whether to use the individual subfields. As the number of these output bits increases, the number of pixels that are ignored in the SF-utilization-rate detecting circuit 6 decreases, resulting in an increasingly accurate determination. However, such increase in the number of the output bits also means an increase in sensitivity to video signal noise. The use of fewer output bits than 20 bits makes it possible to eliminate the erroneous detections caused by noise.

The use of the 8 bits on the MSB side of the normalized values means that SFL becomes 1 when the count reaches 1200 dots. That is, the counts up to 1200 dots (up to a utilization rate of 1/256) will be ignored. In the description that follows, if there is a statement that SFLn is 0 and the utilization rate of the subfield SFbn is zero, the stated situation not only includes a case in which the number of pixels for which the subfield SFbn is lit up is zero, but may also include a case in which a value less than a predetermined utilization rate (e.g., a utilization rate of 1/256) is rounded to zero through the discarding of lower-order bits as described above.

In the present invention, further, when the SF-utilization-rate detecting circuit 6 calculates utilization rates for the entirety of the screen, the obtained outcomes of the additions may be output as they are without normalization. Namely, the SF-utilization-rate detecting circuit 6 may be configured such that only the adder circuits 601 through 610 are provided, without the utilization-rate calculating circuits 611 through 620.

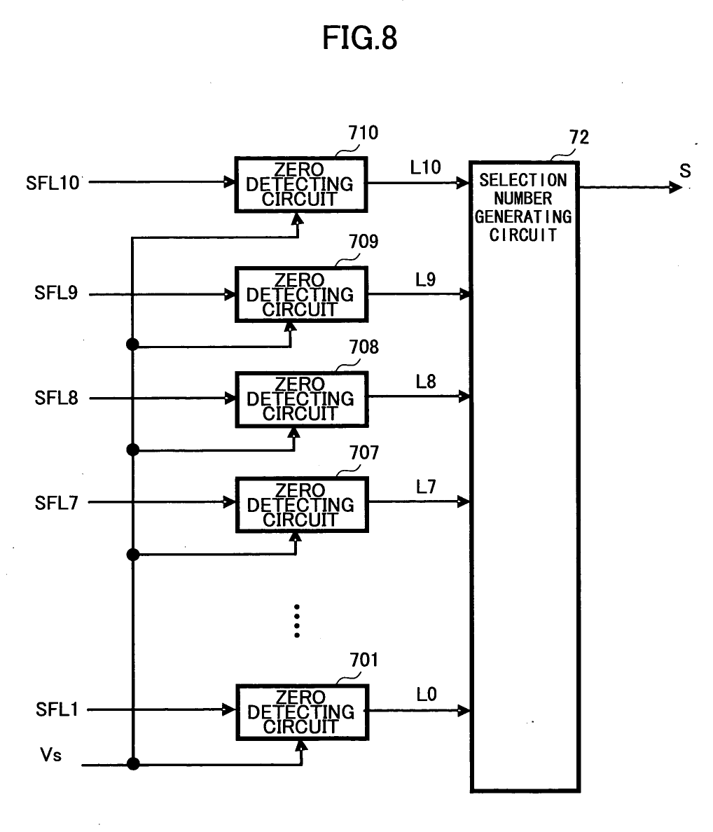

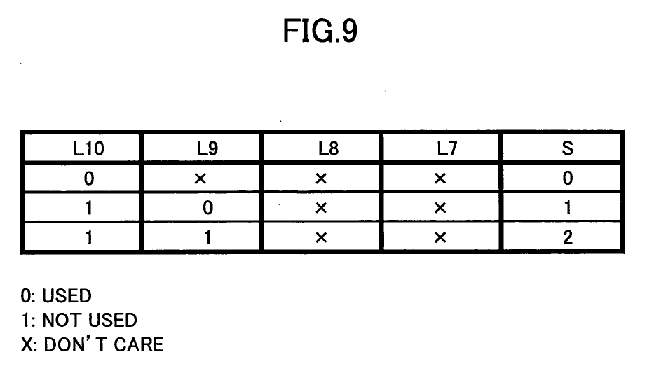

FIG. 8 is a block diagram showing an example of the displayed-SF selecting circuit 7 of the image display apparatus according to the present invention. FIG. 8 shows zero detecting circuits 701 through 710 and a selection number generating circuit 72. FIG. 9 is a drawing showing an example of the table of outputs of the displayed-SF selecting circuit 7 of the image display apparatus according to the present invention.

The zero detecting circuits 701 through 710 detect, separately for each field, whether the values of the outputs SFL1 through SFL10 of the SF-utilization-rate detecting circuit 6 are zero, respectively. The zero detecting circuits 701 through 710 supply signals L1 through L10 to the selection number generating circuit 72. The zero detecting circuits 701 through 710 output “1” when the values of the respective utilization rates SFL1 through SFL10 are “0”, i.e., when the respective subfields SFb1 through SFb10 are not used, and output “0” when the values of the respective utilization rates SFL1 through SFL10 are not “0”. If the 8 bits on the MSB side of the values normalized by the SF-utilization-rate detecting circuit 6 is used as previously described, the counts up to 1200 dots (up to a utilization rate of 1/256) are ignored to produce the utilization rate SFL that is “0”.

The selection number generating circuit 72 outputs a selection signal S shown in FIG. 9 with respect to the utilization rates SFL7 through SFL10. Namely, when the signal L10 output from the zero detecting circuit 710 is “0”, i.e., when the subfield SFb10 is being used, the selection number generating circuit 72 outputs S=0 regardless of the signals L9 through L7 (L9 through L1) output from the zero detecting circuits 709 through 707. Further, when the signal L10 output from the zero detecting circuit 710 is “1” and the signal L9 output from the zero detecting circuit 709 is “0”, i.e., when the subfield SFb10 is not being used and the subfield SFb9 is being used, S=1 is output regardless of the signals L8 and L7 (L8 through L1) output from the zero detecting circuits 708 and 707.

Moreover, when the signals L10 and L9 output from the zero detecting circuits 710 and 709 are both “1”, i.e., when none of the subfields SFb10 and SFb9 is being used, S=2 is output regardless of the signals L8 and L7 (L8 through L1) output from the zero detecting circuits 708 and 707. The output S of the selection number generating circuit 72 is supplied as the output of the displayed-SF selecting circuit 7 to the drive control circuit 5, the multi-level processing circuit 3, and the gain-characteristic generating circuit 10.

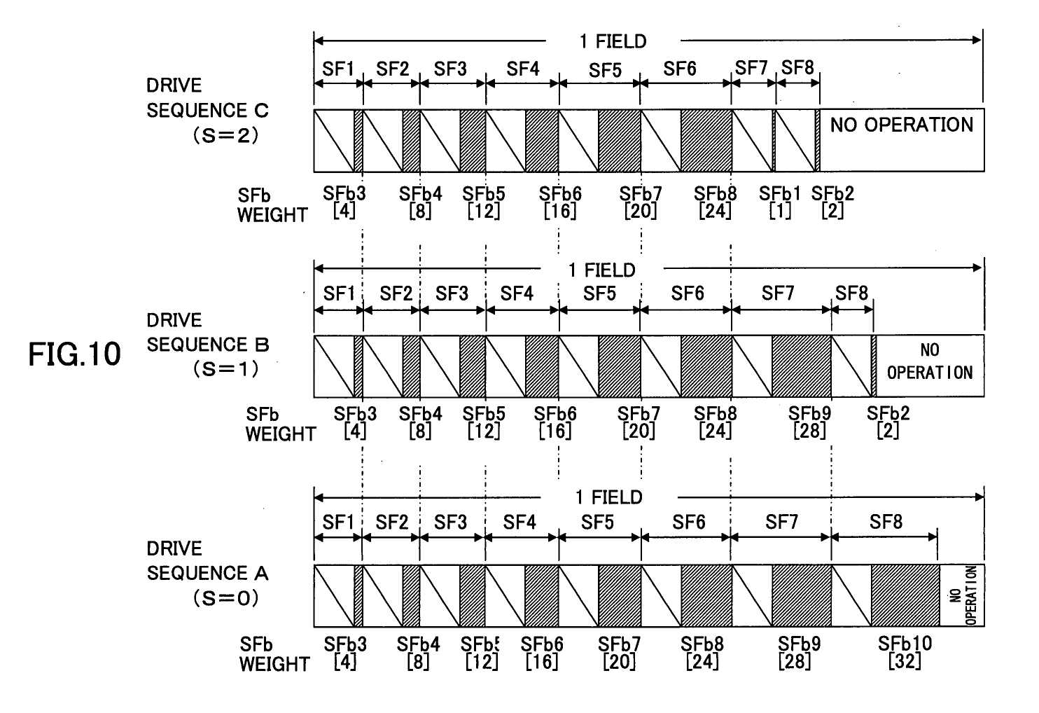

FIG. 10 is a drawing showing an embodiment of a drive sequence of the image display apparatus according to the present invention. FIG. 10 shows an example in which one field is driven by 8 subfields SF1 through SF8.

The drive control circuit 5 switches drive sequences in response to the output S of the displayed-SF selecting circuit 7. As shown in FIG. 10, the drive control circuit 5 drives the display panel 9 by use of a drive sequence A when S=0, drives the display panel 9 by use of a drive sequence B when S=1, and drives the display panel 9 by use of a drive sequence C when S=2.

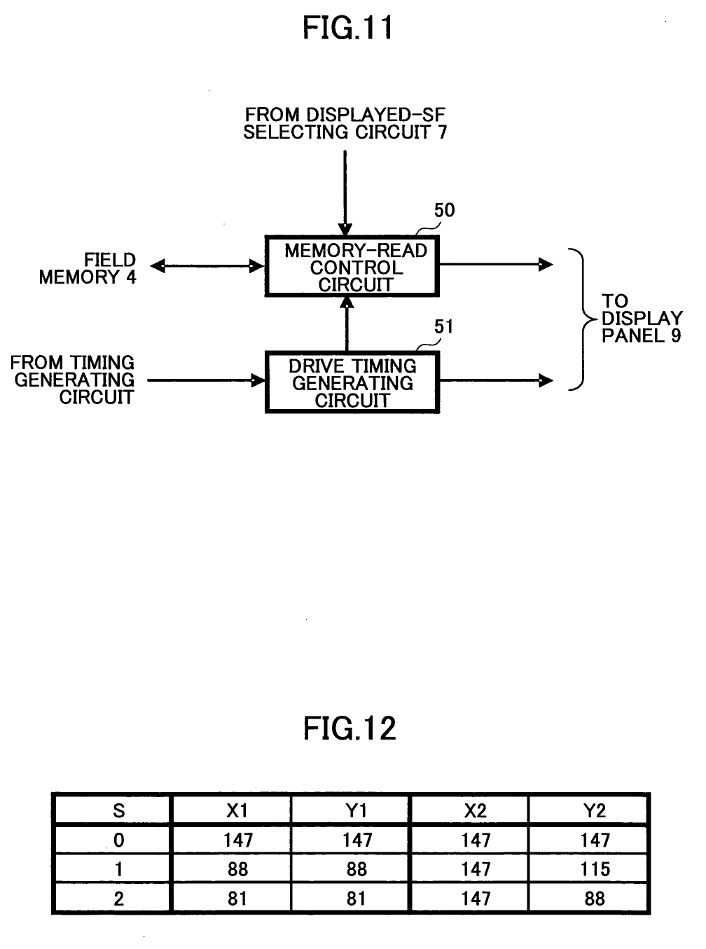

FIG. 11 is a block diagram showing an example of the drive control circuit 5 of the image display apparatus according to the present invention. FIG. 11 shows a memory-read control circuit 50 and a drive timing generating circuit 51 for generating various timing signals necessary for the display apparatus for provision to the display apparatus. These various timing signals are generated based on the synchronizing signals and the like supplied from the timing generating circuit 8.

The memory-read control circuit 50 operates in accordance with timing generated by the drive timing generating circuit 51 to read data from the field memory 4 separately for each subfield SFb with respect to one field as the data is written to the field memory 4 after they are rearranged for each subfield SFb with respect to each line. The read data for each subfield SFb is supplied to the display panel 9. The memory-read control circuit 50 reads data for each subfield SFb stored in the field memory 4 in response to S=0, S=1, or S=2 of the selection signal S output from the displayed-SF selecting circuit 7.

When S is equal to 0, i.e., when the drive sequence A is selected, data are read in the order as follows: SFb3, SFb4, SFb5, SFb6, SFb7, SFb8, SFb9, and SFb10. When S is equal to 1, i.e., when the drive sequence B is selected, data are read in the order as follows: SFb3, SFb4, SFb5, SFb6, SFb7, SFb8, SFb9, and SFb2. When S is equal to 2, i.e., when the drive sequence C is selected, data are read in the order as follows: SFb3, SFb4, SFb5, SFb6, SFb7, SFb8, SFb1, and SFb2.

As was described in connection with FIG. 3 through FIG. 5, the lit-up pattern tables stored in the SF converting circuit 32 of the multi-level processing circuit 3 include the three types of tables A through C, and the switching of lit-up pattern tables is performed in response to the output S of the displayed-SF selecting circuit 7. Namely, the lit-up pattern table A is selected when S=0, the lit-up pattern table B selected when S=1, and the lit-up pattern table C selected when S=2.

FIG. 12 is a drawing showing an example of the table of outputs of the gain-characteristic generating circuit 10 of the image display apparatus according to the present invention. The gain-characteristic generating circuit 10 generates gain-characteristic information indicative of gain characteristics in response to the selection signal S output from the displayed-SF selecting circuit 7. The gain-characteristic information includes coordinates (X1, Y1) and (X2, Y2) representing the connecting points between straight line segments having different slopes, thereby representing changes in the slope of straight line segments constituting the gain characteristics. The gain-characteristic information is supplied to the gain control circuit 30, which performs the switching of gain characteristics.

FIG. 13 is a drawing showing the gain characteristics selected by the gain-characteristic generating circuit 10. The gain characteristic A serves to output the input video signal values after multiplication by 1 as these signal values are input into the gain control circuit. This characteristic is selected when the utilization rate of the subfield SFb10 is not 0, with the displayed-SF selecting circuit 7 outputting S=0.

When the utilization rate of the subfield SFb10 is 0 and the utilization rate of the subfield SFb9 is not 0, i.e., when the selection signal S output from the displayed-SF selecting circuit 7 is 1, the gain characteristic B is selected. In this case, the gain-characteristic generating circuit 10 outputs gain-characteristic information that includes coordinates (X1, Y1)=(88, 88) and (X2, Y2)=(147, 115) representing the connecting points between straight line segments having different slopes.

When the utilization rates of the subfields SFb10 and SFb9 are both zero, i.e., when the selection signal S output from the displayed-SF selecting circuit 7 is 2, the gain characteristic C is selected. In this case, the gain-characteristic generating circuit 10 outputs gain-characteristic information that includes coordinates (X1, Y1)=(81, 81) and (X2, Y2)=(147, 88) representing the connecting points between straight line segments having different slopes.

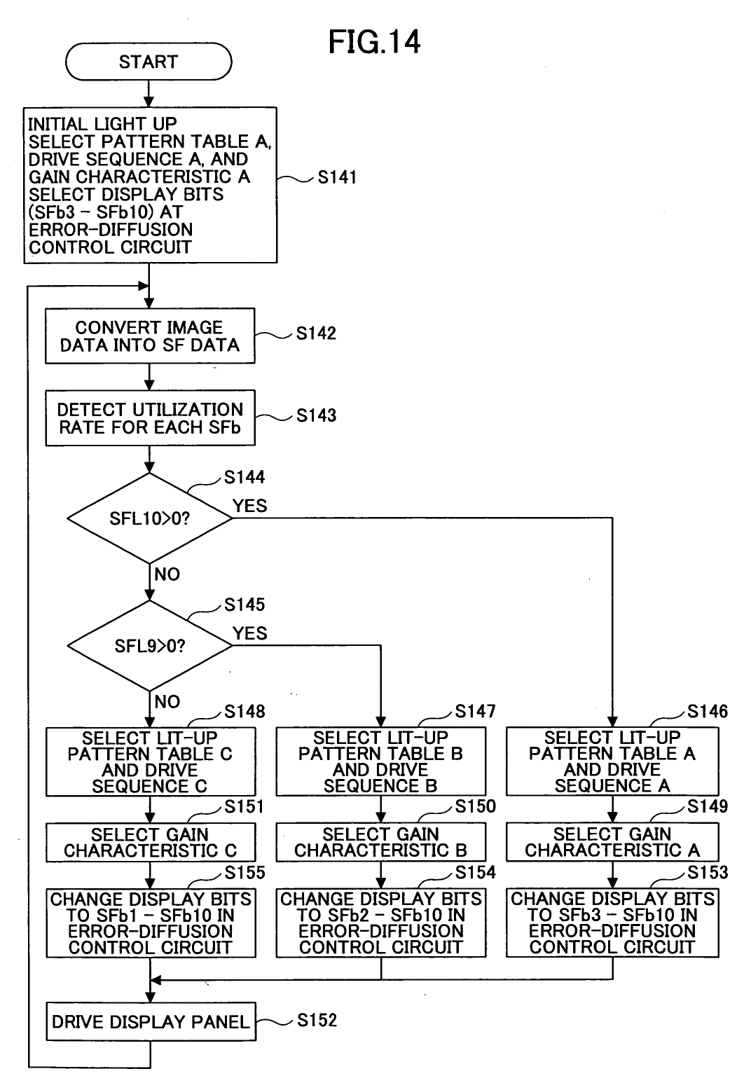

FIG. 14 is a flowchart showing an example of an image displaying process performed by the image displaying apparatus according to the present invention. As the image displaying process starts, the image displaying apparatus is initialized at step S141. When this happens, the lit-up pattern table A shown in FIG. 3 is selected, with the gain characteristic A being selected, and the bits corresponding to SFb3 through SFb10 being selected as the display bits separated by the error-diffusion control circuit 31. Further, the drive sequence A shown at the bottom of FIG. 10 is selected.

At step S142, then, the input image signals are converted into data in the subfields SFb (by the SF converting circuit 32). At step S143, the utilization rate of each subfield SFb is detected (by the SF-utilization-rate detecting circuit 6). A check is then made at step S144 as to whether the utilization rate SFL10 of the subfield SFb10 having the largest weight is larger than zero. At step S145, a check is made as to whether the utilization rate SFL9 of the subfield SFb9 having the second largest weight is larger than zero.

If the check at step S144 finds that the utilization rate SFL10 of the subfield SFb10 is larger than zero, the procedure goes to step S146, at which the drive sequence A and the lit-up pattern table A are selected. Thereafter, the gain characteristic A is selected at step S149. In this case, at step S153, the bits corresponding to SFb3 through SFb10 are selected as the display bits separated by the error-diffusion control circuit 31 as previously described.

If the checks at step S144 and step S145 find that the utilization rate SFL10 of the subfield SFb10 is zero and utilization rate SFL9 of the subfield SFb9 is larger than zero, the procedure goes to step S147, at which the drive sequence B and the lit-up pattern table B are selected. Thereafter, the gain characteristic B is selected at step S150. In this case, at step S154, the bits corresponding to SFb2 through SFb10 are selected as the display bits separated by the error-diffusion control circuit 31 as previously described.

If the checks at step S144 and step S145 find that the utilization rate SFL10 of the subfield SFb10 is zero and utilization rate SFL9 of the subfield SFb9 is also zero, the procedure goes to step S148, at which the drive sequence C and the lit-up pattern table C are selected. Thereafter, the gain characteristic C is selected at step S150. In this case, at step S155, the bits corresponding to SFb1 through SFb10 are selected as the display bits separated by the error-diffusion control circuit 31 as previously described.

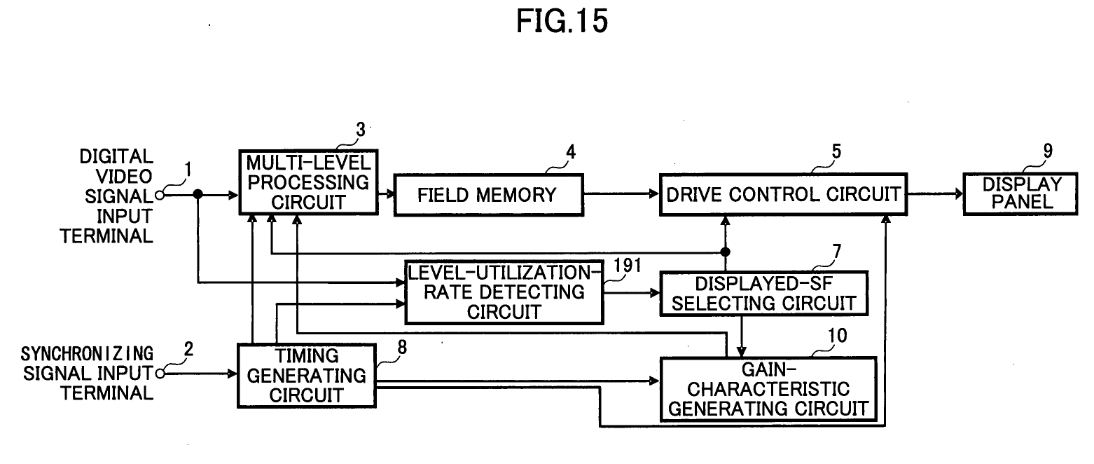

In the following, a second embodiment of the present invention will be described. FIG. 15 is a block diagram showing a second embodiment of the image display apparatus according to the present invention. In FIG. 15, the same elements as those of FIG. 1 are referred to by the same numerals, and a description thereof will be omitted.

In the image display apparatus of FIG. 15, a level-utilization-rate detecting circuit 191 is used in place of the SF-utilization-rate detecting circuit 6. The level-utilization-rate detecting circuit 191 detects the utilization rates of individual levels of the digital video signals input into the digital video signal input terminal 1, and supplies the detection results to the displayed-SF selecting circuit 7. In response to the level-specific utilization rates output from the level-utilization-rate detecting circuit 191, the displayed-SF selecting circuit 7 outputs a selection signal that selects one of a plurality of lit-up pattern tables. The lit-up pattern tables used in this configuration may be the same as those shown in FIG. 3 through FIG. 5.

In this case, the level-utilization-rate detecting circuit 191 counts the number of pixels for which the level of the digital video signals exceeds a first predetermined value so as to derive the utilization rate of the subfield SFb10, and also counts the number of pixels for which the level of the digital video signals exceeds a second predetermined value so as to derive the utilization rate of the subfield SFb9. In this manner, the level-utilization-rate detecting circuit 191 directly checks the levels of digital video signals to count the number of pixels having signal levels corresponding to the subfield SFb10 and/or the subfield SFb9. Because of this, the lit-up data for SFb10 and/or SFb9 in the lit-up pattern table shown in FIG. 3 through FIG. 5 are not used for the purpose of pixel counting. Accordingly, the data for SFb10, for example, may be the same between all the lit-up pattern tables.

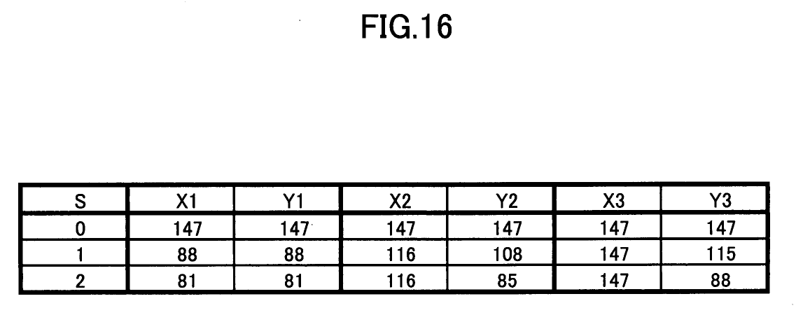

Moreover, the gain characteristics used in the second embodiment is different from those used in the first embodiment. FIG. 16 is a drawing showing an example of the table of outputs of the gain-characteristic generating circuit of the image display apparatus according to the present invention. The points at which the slope of the gain characteristics changes are increased in number compared with those used in the first embodiment, so that the number of data items included in the gain-characteristic information is lager than in the first embodiment.

In the following, a third embodiment of the present invention will be described. The image display apparatus used in the third embodiment may have the same configuration as that shown in FIG. 1 or that shown in FIG. 15.

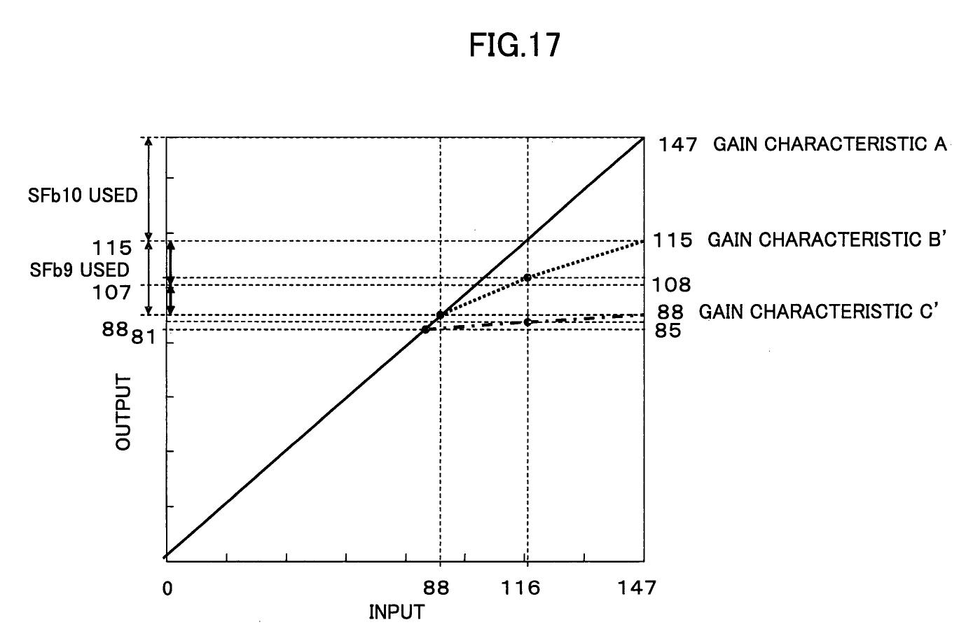

FIG. 17 is a drawing showing the gain characteristics generated by the gain-characteristic generating circuit used in this embodiment. Unlike those used in the first embodiment, gain characteristics B′ and C′ generated by the gain-characteristic generating circuit according to this embodiment has multiple points at which the slope of the gain changes. With the provision of the multiple slopes, gain changes are made small, so that odd visual appearance corresponding to the points of gain changes can be further suppressed compared with the case in which there is only one point at which the slope of gain characteristics changes.

When the output S of the displayed-SF selecting circuit 7 is 0, the gain-characteristic generating circuit 10 outputs to the gain control circuit 30, as gain-characteristic information representing the gain characteristic A, coordinates (X1, Y1)=(147, 147), (X2, Y2)=(147, 147), and (X3, Y3)=(147, 147) representing the connecting points between straight line segments having different slopes. In this case, the graph representing the gain characteristic becomes a single straight line which is a gain characteristic that outputs the input video signal values after multiplication by one.

When the output S of the displayed-SF selecting circuit 7 is 1, the gain-characteristic generating circuit 10 outputs to the gain control circuit 30, as gain-characteristic information representing the gain characteristic B′, coordinates (X1, Y1)=(88, 88), (X2, Y2)=(116, 108), and (X3, Y3)=(147, 115) representing the connecting points between straight line segments having different slopes. This is a gain characteristics by which the input video signal values up to the grayscale tone “88” are multiplied by one for outputting, and the slope of the gain becomes gentler for grayscale tones exceeding the tone “88”, becoming further gentler for the grayscale tone “116” and larger, with the maximum output being limited to 115.

When the output S of the displayed-SF selecting circuit 7 is 2, the gain-characteristic generating circuit 10 outputs to the gain control circuit 30, as gain-characteristic information representing the gain characteristic C′, coordinates (X1, Y1)=(81, 81), (X2, Y2)=(116, 85), and (X3, Y3)=(147, 88) representing the connecting points between straight line segments having different slopes. This is a gain characteristics by which the input video signal values up to the grayscale tone “81” are multiplied by one for outputting, and the slope of the gain becomes gentler for grayscale tones exceeding the tone “81”, becoming further gentler for the grayscale tone “116” and larger, with the maximum output being limited to 88.

It should be noted that the points at which the slopes of the straight line segments constituting the gain characteristic change are not limited to a particular number, and any number of points of changes may be provided according to need. Further, the input/output characteristics may be set such that the slope of the straight line segments decreases as the value of the input signals increases.

In the following, a fourth embodiment of the present invention will be described. The image display apparatus used in the fourth embodiment may have the same configuration as that shown in FIG. 1 or that shown in FIG. 15.

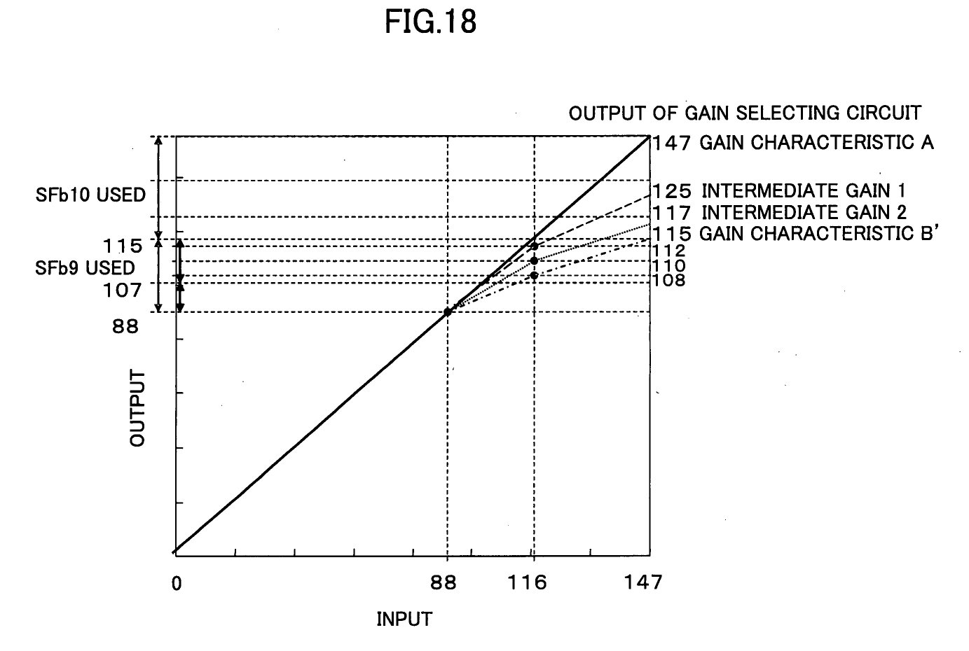

In the fourth embodiment, the gain is changed gently at the time of switching gain characteristics by using one or more intervening intermediate stages between the currently selected gain characteristic and the gain characteristic to be used next, thereby suppressing an adverse effect associated with the switching of gain characteristics. When a transition is made from the drive sequence A using the subfield SFb10 to the drive sequence B not using the subfield SFb10, for example, the gain may be changed frame by frame in the order as follows: the gain characteristic A, an intermediate gain 1, an intermediate gain 2, and the gain characteristic B′ as shown in FIG. 18.

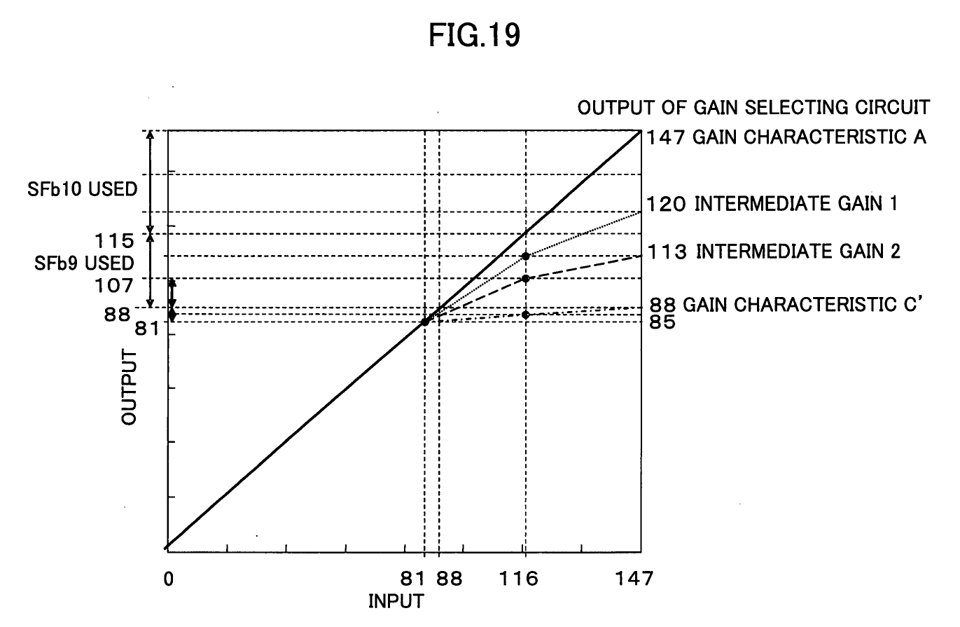

When a transition is made from the drive sequence A using the subfield SFb10 to the drive sequence C using none of the subfields SFb9 and SFb10, for example, the gain may be changed frame by frame in the order as follows: the gain characteristic A, an intermediate gain 1, an intermediate gain 2, and the gain characteristic C′ as shown in FIG. 19.

By the same token, the gain is gently changed (gradually changed step by step) in the same manner by using intervening stages when a transition is made from the drive sequence B to the drive sequence C or when transitions reverse to those described above are made.

In the following, a fifth embodiment of the present invention will be described. The image display apparatus used in the fifth embodiment may have the same configuration as that shown in FIG. 1 or that shown in FIG. 15.

In the fifth embodiment, the selection signal S output from the displayed-SF selecting circuit 7 is configured to have hysteresis characteristics. With the provision of hysteresis characteristics in the selection signal S, trouble associated with frequent switching at short intervals can be reduced.

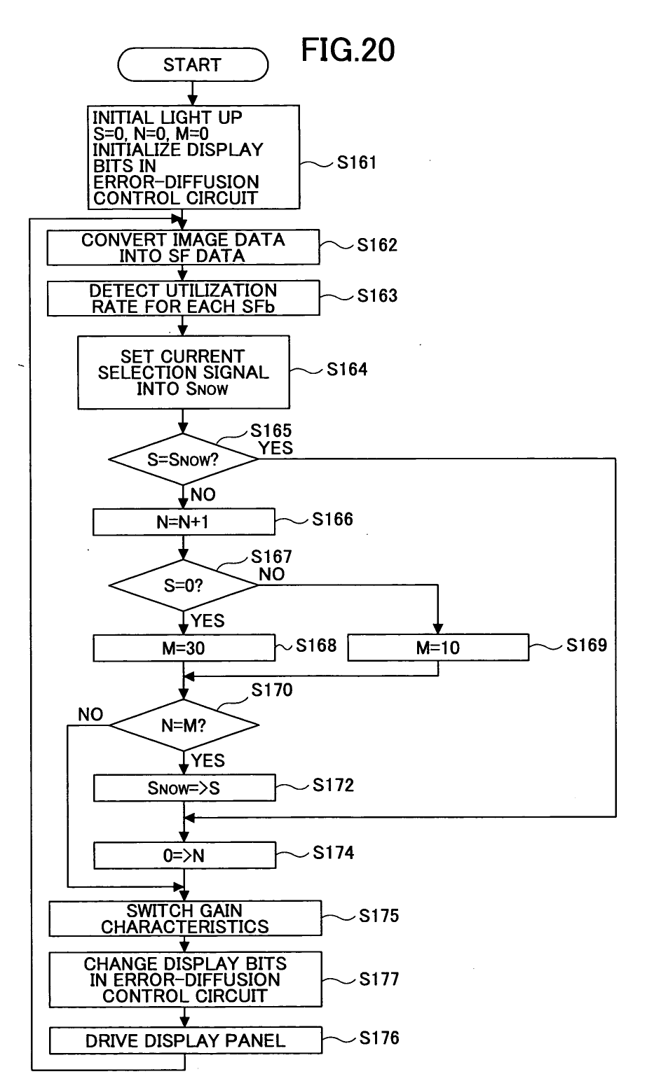

FIG. 20 is a flowchart showing an example of an image displaying process performed by the fifth embodiment of the image displaying apparatus according to the present invention.

As the displayed-SF selection process starts in FIG. 20, at step S161, the displayed-SF selecting circuit 7 is initialized, by which the selection signal S is set to 0, and parameters N and M for providing hysteresis characteristics are both set to 0. Further, the bits corresponding to SFb3 through SFb10 are selected as the display bits separated by the error-diffusion control circuit 31.

At step S162, the input image data are converted into data in the subfields SFb (by the SF converting circuit 32). At step S163, the utilization rate of each subfield SFb is detected. This process corresponds to that performed by the SF-utilization-rate detecting circuit 6 described in connection with FIG. 8. At step S164, further, the selection signal generated based on the current output of the selection number generating circuit 72 described in connection with FIG. 9 is set into S_{NOW}.

At step S165, then, comparison is made between the previous output S of the displayed-SF selecting circuit 7 and current S_{NOW}. If S=S_{NOW}, the procedure goes to step S174. If S is not equal to S_{NOW}, the procedure goes to step S166, at which one is added to the parameter N (i.e., N=N+1).

If S is 0 at step S167, M is set to 30 (step S168). If current S is 1, M is set to 10 (step S169). The procedure then proceeds to step S170.

With the arrangement described above, S is switched to 1 when S_{NOW} stays 1 thirty times consecutively while S is 0, whereas S is switched to 0 when S_{NOW} stays 0 ten times consecutively while S is 1. This makes it possible to change the number of consecutive detections depending on the current value of S, thereby adjusting the hysteresis characteristics. It should be noted that the value “30” at step S168 and the value “10” at step S169 may be changed as appropriate.

At step S170, a check is made as to whether N is equal to M. If the check finds that N is equal to M, the procedure proceeds to step S172. If the check finds that N is not equal to M, the procedure proceeds to step S175.

At step S172, S_{NOW} is changed to S (S_{NOW} [symbol] S), and the procedure proceeds to step S174. At step S174, the parameter N is returned to 0 (0 [symbol] N), and the procedure proceeds to step S175.

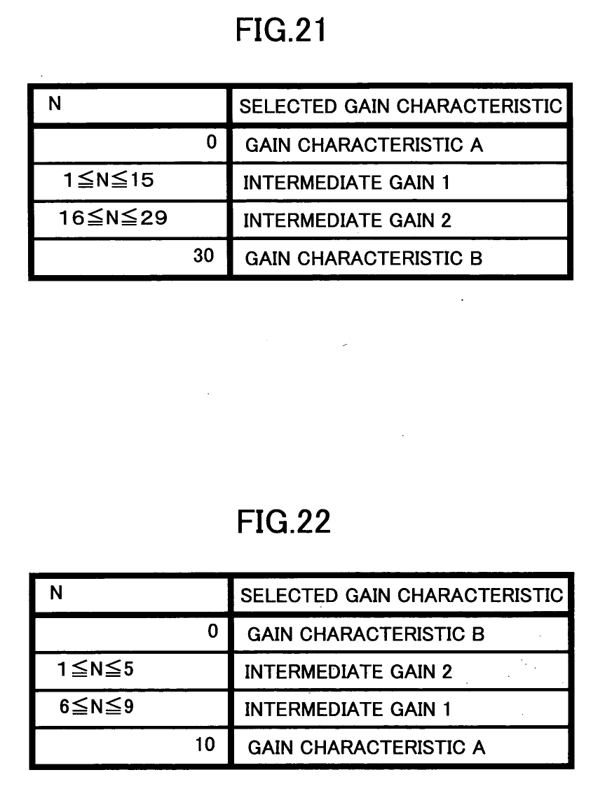

FIG. 21 is a drawing showing a process performed at step S175 when M is equal to 30. In this example, the switching of gain characteristics is performed gently (gradually on a step-by-step basis) by using intermediate gain characteristics as in the fourth embodiment.

At step S175, intermediate gain characteristics are used such that the gain characteristic gradually approaches the gain characteristic specified by S. The gain characteristic selected by the gain-characteristic generating circuit 10 is chosen according to the value of N.

The gain characteristic A is selected if N is 0. The intermediate gain 1 is selected if N is larger than or equal to 1 and smaller than or equal to 15. The intermediate gain 2 is selected if N is larger than or equal to 16 and smaller than or equal to 29. The gain characteristic B is selected if N is 30.

FIG. 22 is a drawing showing a process performed at step S175 when M is equal to 10. The gain characteristic B is selected if N is 0. The intermediate gain 2 is selected if N is larger than or equal to 1 and smaller than or equal to 5. The intermediate gain 1 is selected if N is larger than or equal to 6 and smaller than or equal to 9. The gain characteristic A is selected if N is 10. Then, at step S177, the display bits separated by the error-diffusion control circuit 31 are selected in response to the selection signal S. SFb3 through SFb10 are selected when S=0, SFb2 through SFb10 selected when S=1, and SFb1 through SFb10 selected when S=2.

The procedure then proceeds to step S176 after the processes as described above. The display panel is driven at step S176, and, then, the procedure returns to step S162 to repeat the same processes.

In the description provided above, the lit-up pattern tables used in the SF converting circuit 32 are not limited to three types, but may be any number of types larger than or equal to two. Further, the intermediate gains generated by the gain-characteristic generating circuit 10 are not limited to two types, but may be any number of types. Moreover, the output bits of the SF-utilization-rate detecting circuit 6 may be switched as previously described, thereby performing fine adjustment of the hysteresis characteristics.

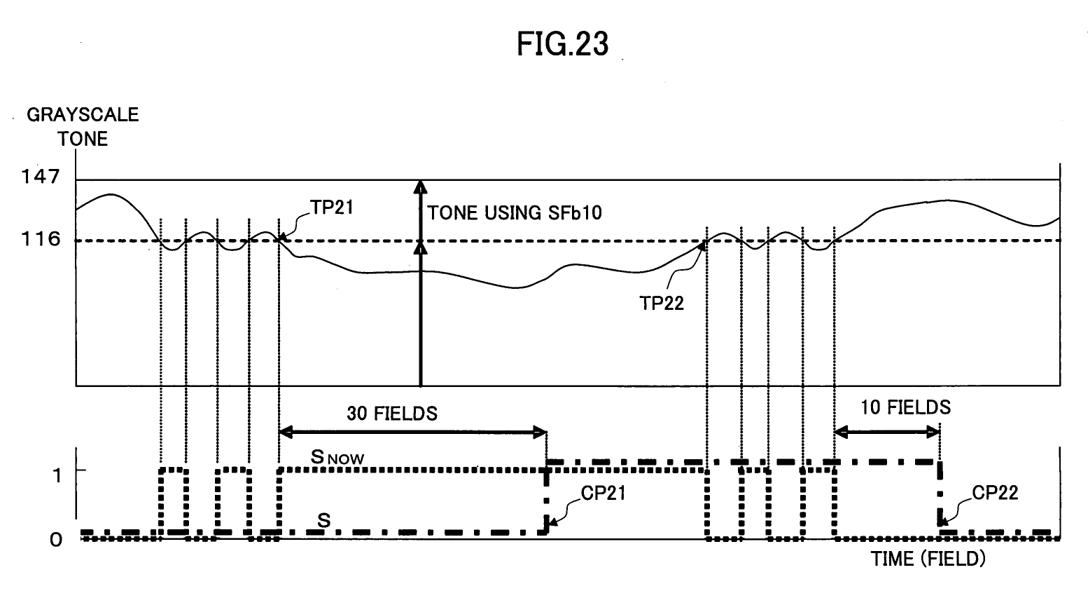

FIG. 23 is a drawing showing an example of the hysteresis characteristics of the selection signal S output from the displayed-SF selecting circuit 7. This illustration is intended to explain the hysteresis characteristics that occur at the switching of selection signals according to the displayed-SF selection process and gain characteristics shown in the flowchart of FIG. 18.

As shown in FIG. 23, the selection signal S is changed from 0 to 1 at timing CP21 that is 30 fields after timing TP21 at which the peak value of the video signals falls below the grayscale tone “115” so as not to use the subfield SFb10. Further, the selection signal S is changed from 1 to 0 at timing CP22 that, is 10 fields after timing TP22 at which the peak value of the video signals rises above the grayscale tone “115” so as to use the subfield SFb10.

As can be seen from comparison between the output signal S of the displayed-SF selecting circuit 7 and the selection signal SNOW shown at the bottom of FIG. 23, the displayed-SF selection process shown in FIG. 20 can provide hysteresis characteristics to the switching of levels of the selection signal S, thereby avoiding the switching of levels of the selection signal S at short intervals.

According to the displayed-SF selection process shown in FIG. 20, the value (30) set into M at step S168 is larger than the value (10) set into M at step S169, so that it is harder to change from S=0 to S=1 than to change from S=1 to S=0. This can avoid saturation at the high luminance areas of the video signals corresponding to the subfield SFb10.

Although the above embodiments have been described by using a plasma display apparatus as an example to which the present invention is applied, the image display apparatus of the present invention is not limited to a plasma display apparatus. Further, the weights of the subfields in the present invention are not limited to the weights of lit-up data, and may be weights of luminance.

Further, the present invention is not limited to these embodiments, but various variations and modifications may be made without departing from the scope of the present invention.

The present invention is applicable to a wide variety of image display apparatuses including a plasma display apparatus, and can be applied to a display apparatus for a personal computer, a work station, or the like, a flat-screen wall-hung television, or an image display apparatus for use as a device to display advertisement, information, or the like.

The present application is based on Japanese priority application No. 2006-038525 filed on Feb. 15, 2006, with the Japanese Patent Office, the entire contents of which are hereby incorporated by reference.

What is claimed is:

1. An image display apparatus, which divides one field into a plurality of weighted subfields, and controls a on/off state of the subfields in accordance with a lit-up pattern table defining an on/off state of each of the subfields with respect to each level of an input image signal, thereby displaying a multi-level image on a display panel, comprising:
a displayed-subfield selecting circuit configured to select a lit-up pattern table from a plurality of lit-up pattern tables in response to an input image signal;
a gain-characteristic generating circuit configured to select, from a plurality of gain characteristics, a gain characteristic corresponding to the selected lit-up pattern table; and
a gain control circuit configured to produce a gain-limited image signal made by limiting a maximum level of the input image signal in response to the selected gain characteristic,
wherein the on/off state of the subfields is controlled in response to a level of the gain-limited image signal in accordance with the selected lit-up pattern table, thereby displaying a multi-level image on the display panel.

2. The image display apparatus as claimed in claim 1, further comprising a utilization-rate detecting circuit configured to detect a number of pixels exceeding a predetermined signal level in one field based on data that controls the on/off state of the subfields in response to a level of the gain-limited image signal in accordance with the selected lit-up pattern table, and to output a detection result responsive to the detected number of pixels, wherein the display-subfield selecting circuit selects the selected lit-up pattern table in response to the detection result output from the utilization-rate detecting circuit.

3. The image display apparatus as claimed in claim 1, further comprising a utilization-rate detecting circuit configured to detect a number of pixels exceeding a predetermined signal level in one field based on the input image signal, and to output a detection result responsive to the detected number of pixels, wherein the display-subfield selecting circuit selects the selected lit-up pattern table in response to the detection result output from the utilization-rate detecting circuit.

4. The image display apparatus as claimed in claim 1, wherein the gain control circuit is configured to change levels of the gain-limited image signal gradually on a step-by-step basis through a plurality of steps in accordance with an output of the gain-characteristic generating circuit.

5. The image display apparatus as claimed in claim 1, wherein the gain-characteristic generating circuit is configured to generate a gain characteristic that is an input/output characteristic comprised of one or more straight line segments having different slopes.

6. The image display apparatus as claimed in claim 1, wherein the gain-characteristic generating circuit is configured to generate a gain characteristic that is an input/output characteristic specifying that a slope of a straight line segment decreases as a level of the input image signal increases.

7. The image display apparatus as claimed in claim 1, wherein the gain-characteristic generating circuit is configured to select, as the selected gain characteristic, a gain characteristic in which levels of the gain-limited image signal are smaller than or equal to a maximum grayscale tone that is presentable when the multi-level image is presented on the display panel in accordance with the selected lit-up pattern table.

8. The image display apparatus as claimed in claim 2, wherein the plurality of lit-up pattern tables and the plurality of gain characteristics are configured such that the detected number of pixels detected by the utilization-rate detecting circuit is substantially constant for the same input image signal regardless of which one of the plurality of lit-up pattern tables is selected and regardless of which one of the plurality of gain characteristics is selected.

9. The image display apparatus as claimed in claim 1, wherein the displayed-subfield selecting circuit is configured to switch lit-up pattern tables in response to an even that a number of pixels exceeding a predetermined signal level in one field included in the input image signal drops below a predetermined value.

10. The image display apparatus as claimed in claim 1, wherein the displayed-subfield selecting circuit is configured to select the selected lit-up pattern table in response to the input image signal of a current field and a lit-up pattern table selected for a previous field.

11. The image display apparatus as claimed in claim 1, wherein switching of lit-up pattern tables by the displayed-subfield selecting circuit in response to a change in the input image signal is configured to have hysteresis characteristics.

12. A method of driving an image display apparatus, which divides one field into a plurality of weighted subfields, and controls a on/off state of the subfields in accordance with a lit-up pattern table defining an on/off state of each of the subfields with respect to each level of an input image signal, thereby displaying a multi-level image on a display panel, the method comprising:
a step of selecting a lit-up pattern table from a plurality of lit-up pattern tables in response to an input image signal;
a step of selecting, from a plurality of gain characteristics, a gain characteristic corresponding to the selected lit-up pattern table;
a step of producing a gain-limited image signal made by limiting a maximum level of the input image signal in response to the selected gain characteristic; and
a step of displaying a multi-level image on the display panel by controlling the on/off state of the subfields in response to a level of the gain-limited image signal in accordance with the selected lit-up pattern table.

13. The method as claimed in claim 12, wherein the step of selecting a lit-up pattern table switches lit-up pattern tables in response to an even that a number of pixels exceeding a predetermined signal level in one field included in the input image signal drops below a predetermined value.
